(19) United States
(12) Patent Application Publication
(10) Pub. No.: US 2018/0159093 A1
(43) Pub. Date: Jun. 7, 2018

(54) BIOCOMPATIBLE HYDROPHOBIC BATTERIES, SYSTEMS AND METHODS RELATED THERETO

(71) Applicant: Landsdowne Laboratories, Inc., Boston, MA (US)

(72) Inventors: Sumner A. Barenberg, Englewood, NJ (US); Jeffrey M. Karp, Brookline, MA (US); Bryan Laulicht, Danbury, CT (US)

(21) Appl. No.: 15/805,757

(22) Filed: Nov. 7, 2017

Related U.S. Application Data
(63) Continuation of application No. PCT/US16/31226, filed on May 6, 2016.
(60) Provisional application No. 62/208,259, filed on Aug. 21, 2015.
(60) Provisional application No. 62/158,253, filed on May 7, 2015.

(51) Int. Cl. H01M 2/02; H01M 10/04; H01M 2/08

(52) U.S. Cl. CPC H01M 2/0267; H01M 10/0427; H01M 2220/30; H01M 2/08; H01M 2/0222

(57) ABSTRACT

This invention relates to a battery comprising a hydrophobic component disposed on or in the battery that can reduce the batteries contact with water thereby providing a safer battery in case of ingestion.

### REFERENCE TO RELATED APPLICATIONS

This application is a continuation of Application No. PCT/US16/031226, filed May 6, 2016, which claims the benefit of U.S. Provisional Patent Application No. 62/208,259, filed Aug. 21, 2015, and of U.S. Provisional Patent Application No. 62/158,253, filed May 7, 2015, the contents of each of which are fully incorporated by reference herein in their entireties.

### BACKGROUND OF THE INVENTION

The widespread use of batteries to power many items including remote controls, flashlights, cameras, car key fobs, calculators, bathroom scales, reading lights, flameless candles, talking books, singing greeting cards, watches, thermometers, hearing aids, flashing jewelry, ornaments, games and toys creates an increased opportunity for ingestion. Children are particularly at risk to ingest batteries due to the accessibility and presence of these devices in the home. Recently, there was reported a nearly 7-fold increase in the percentage of reported button battery ingestions between 1985 and 2009.

Accidental ingestion has the strong potential for corrosive injury to the gastrointestinal tract with major complications, including esophageal burns, fistula, or perforation. Due to the electrochemistry, batteries retained in the esophagus may cause extensive damage including serious injuries and even death. While ingestion of batteries creates an immediate choking hazard, prolonged injury is due in large part to an electrical current from the battery that generates hydroxide ions through an electrolysis reaction that occurs when the battery is in contact with tissue fluids, such as saliva. A battery lodged in the esophagus or elsewhere in the digestive tract can cause serious injuries in as little as two hours. Moreover, such a battery may be mistaken for a coin when x-rayed, leading to delays in proper treatment.

Batteries that are more readily identifiable as batteries when x-rayed and are less damaging when ingested are needed.

### SUMMARY OF INVENTION

In one aspect, the present invention provides a battery comprising an anode cap; a cathode housing; an electrochemical cell comprising an anode material, a cathode material, and a separator disposed between the anode material and the cathode material; a gasket joining the anode cap to the cathode housing; and a hydrophobic component disposed on a surface of at least one of the anode cap, the cathode housing, and the gasket. In certain embodiments, the hydrophobic component is a coating.

In certain embodiments, the hydrophobic component has a contact angle greater than about 100° , contact angle greater than about 120° , a contact angle greater than about 135° , greater than about 150° , or even greater than about 165° .

In certain embodiments, wherein the hydrophobic component has a surface energy less than about 35 dynes/cm, less than about 30 dynes/cm, or even less than about 25 dynes/cm.

In certain embodiments, the hydrophobic component further comprises a superhydrophobic surface. In certain embodiments, the superhydrophobic surface is a coating. In certain embodiments, superhydrophobic surface comprises a patterned metal surface. In certain embodiments, superhydrophobic coating comprises nanoparticles.

In certain embodiments, the hydrophobic component comprises a polysilazane.

In certain embodiments, the hydrophobic component comprises a metal, such as nanoparticles or microparticles, of a material selected from metallic nickel, reduced titania, metallic zirconium, silver, silver plated nickel, silver plated aluminum, silver plated copper, carbon, gold, lithium, a lithium-based alloy, titanium, grade 2 titanium, titanium nitride, a titanium-based alloy, nickel, metallic copper tin, zinc, a copper-tin-zinc alloy, tantalum, niobium, boron-doped diamond, stainless steel, grade 304 stainless steel, duplex stainless steel and combinations thereof.

In certain embodiments, the hydrophobic component is provided as a pattern coating. In certain embodiments, the pattern coating is a mesh.

In certain embodiments, the battery further comprises a radiopaque element. In certain embodiments, the battery is a button or a coin cell.

In certain implementations, the battery is a button or a coin cell.

### BRIEF DESCRIPTION OF THE DRAWINGS

FIG. 1 is a schematic cross-sectional view of a conventional button battery, according to an illustrative implementation.

FIG. 2 is a schematic cross-sectional view of an embodiment comprising a hydrophobic component on the exterior surface of the battery, according to an illustrative implementation.

FIG. 3 is a schematic cross-sectional view of an embodiment comprising a hydrophobic component on the anode cap, according to an illustrative implementation.

FIG. 4 is a schematic cross-sectional view of an embodiment comprising a hydrophobic component disposed in the gasket, according to an illustrative implementation.

FIG. 5 is a schematic cross-sectional view of an embodiment comprising a hydrophobic component on the cathode housing, according to an illustrative implementation.

FIG. 6 is a schematic cross-sectional view of an embodiment comprising a patterned superhydrophobic coating disposed on an anode cap.

### DETAILED DESCRIPTION

In the following description, numerous details are set forth for the purpose of explanation. However, those of ordinary skill in the art will realize that the implementations described herein may be practiced without the use of these specific details and that the implementations described herein may be modified, supplemented, or otherwise altered without altering the scope of the batteries, systems, and methods described herein. The batteries, systems, and methods described herein relate to batteries designed to reduce the risks associated with ingestion.

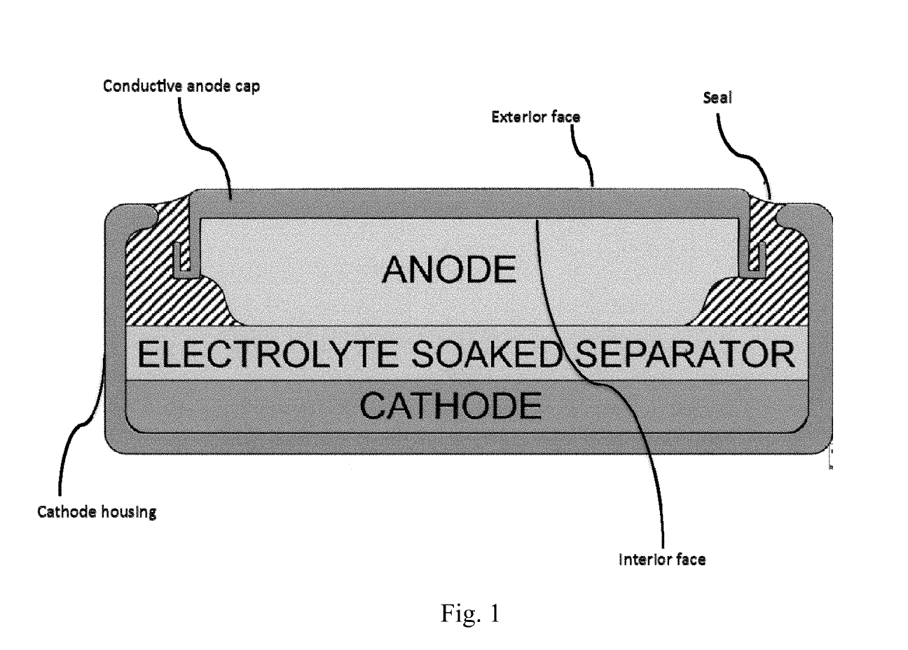

FIG. 1 is a cross-sectional view schematically illustrating the structure of a conventional button battery. See also http://emedicine.medscape.com/article/774838-overview. As illustrated in FIG. 1, a cathode housing having a closed end contains a cathode layer, an electrolyte-soaked separator, and an anode with a conductive anode cap. A seal or gasket holds the conductive anode cap to the cathode casing. In addition, the seal electrically insulates the conductive anode cap from the cathode housing. The electrolyte-soaked separator creates a barrier between the cathode and anode, preventing them from touching while allowing electrical charge to flow freely between them. When a load completes the circuit across the conductive anode cap and the cathode housing, the battery produces electricity through a serious of electrochemical reactions between the anode, cathode and electrolytes.

The anode cap and the cathode housing are conductive materials, and may include a metal, a polymer, or some other suitable material. The anode material may be a lithium compound or some other suitable anode material. The cathode material may be manganese dioxide or some other suitable cathode material. The separator is a permeable membrane that permits the transport of ionic charge carriers, and may comprise electrolyte-soaked fibers, a polymer film, or some other suitable barrier. The gasket may be an electrically insulating ring forming a seal on part of the anode material and the cathode material, and may be a polymer.

One aspect of the present invention is to provide a battery with a hydrophobic component suitable to reduce the wetting of a battery in an aqueous solution, such as saliva or other bodily fluids present in the esophagus and digestive tract of an individual. While not intending to be bound by theory, the hydrophobic component may reduce the battery's contact with water thus reducing the generation of hydroxide ion that occurs when a conventional battery contacts water.

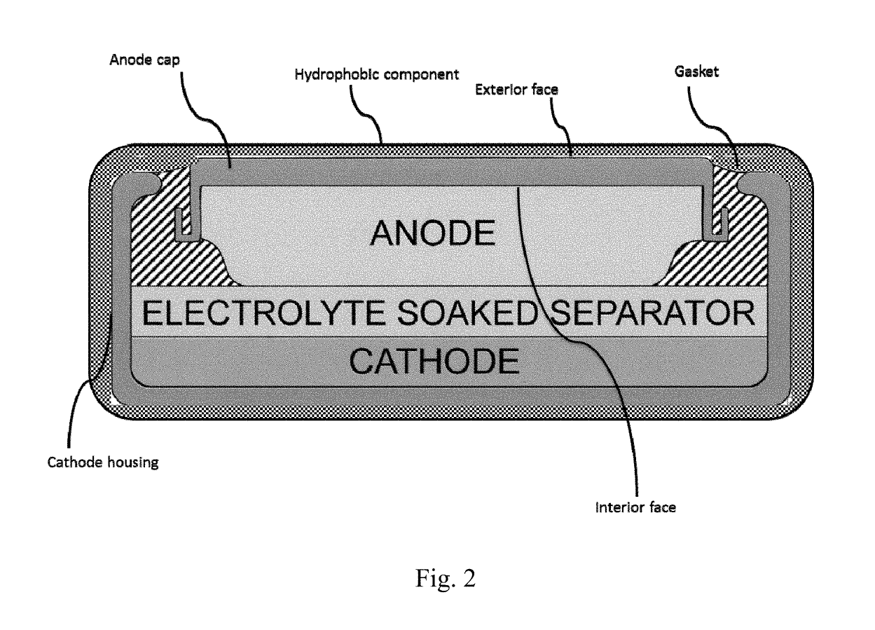

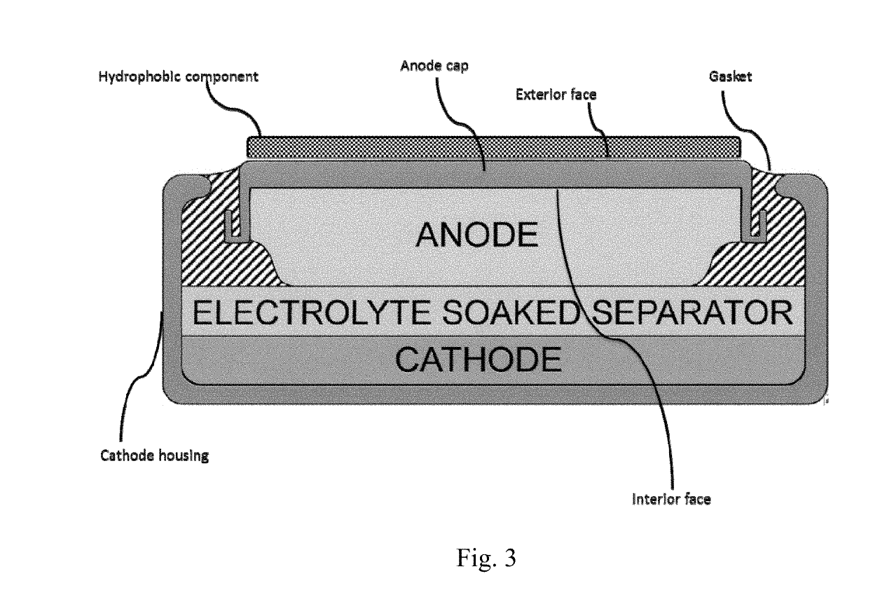

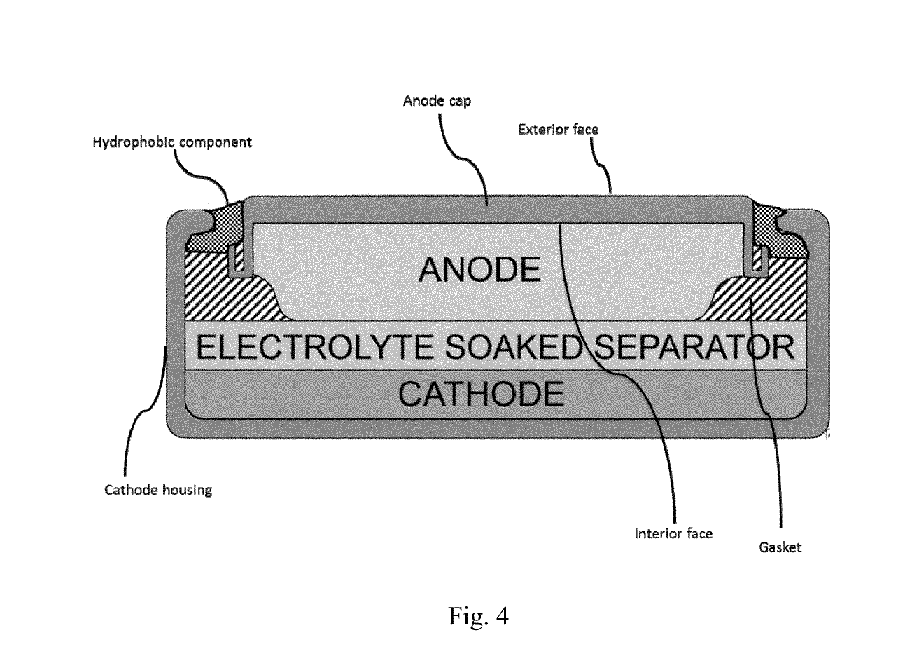

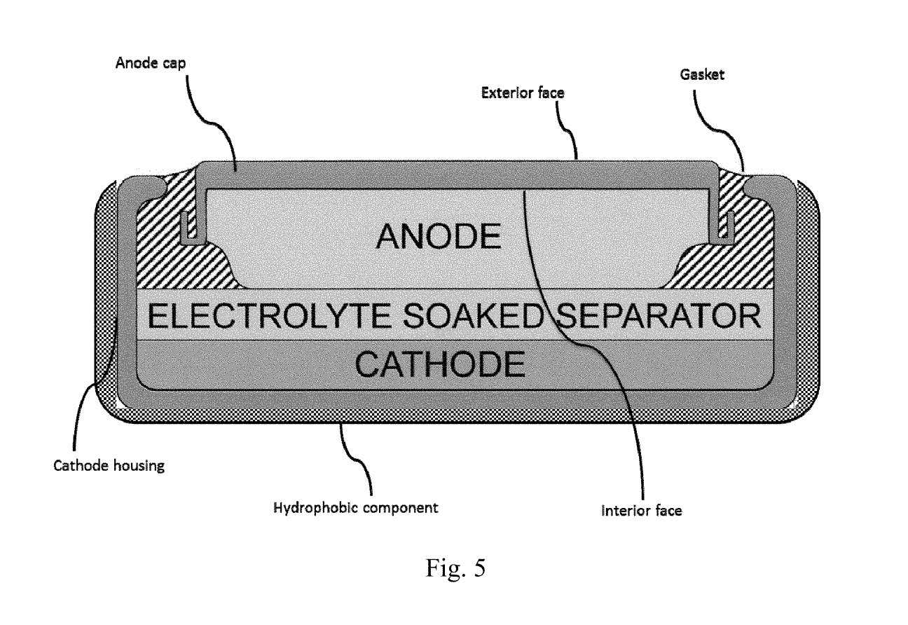

In certain embodiments, the hydrophobic component is disposed on the exterior surfaces of the battery. See, for example, FIG. 2. In certain embodiments, the hydrophobic component is disposed on an exterior surface of the anode cap (e.g., see FIG. 3). In certain embodiments, the hydrophobic component is disposed in the gasket or on an exterior surface of the gasket (e.g., see FIG. 4). In certain embodiments, the hydrophobic component is disposed on an exterior surface of the cathode housing (e.g., see FIG. 5). In certain preferred embodiments, the hydrophobic component has a thickness from about 2.5 nanometers to about 150,000 nanometers, from about 2.5 nanometers to about 127,000 nanometers (e.g., about 5 mils), or from about 2.5 nanometers to about 100,000 nanometers (e.g., about 100 microns).

In certain embodiments, the hydrophobic component may comprise polysilazanes, polyolefins, polyhaloolefins, polyarylene sulfides, and sulfone polymers including, but not limited to, perhydropolysilazanes, polyperhydridosilazanes (PHPS), inorganic polysilazanes, organopolysilazanes (e.g., the polysilazanes sold under the trademark Durazane by EMD Performance Materials), polyethylene, polypropylene, polybutylene, polymethylpentylene, polytetrafluoroethylene (PTFE), polyvinyl fluoride (PVF), polyvinylidene fluoride (PVDF), polychlorotrifluoroethylene (PCTFE), polyvinyl chloride (PVC), polyvinylidene chloride (PVDC), chlorinated polyvinylchloride (C-PVC), fluorinated ethylene-propylene copolymer (FEP), ethylene-chlorotrifluoroethylene copolymer (E-CTFE), ethylene-tetrafluoroethylene copolymer (ETFE), perfluoroalkoxy resin (PFA), propylene hexafluoride such as sold under the trademark TEFLON® EPE, polyphenylene sulfide, polynaphthalene sulfide, hydrophobic silicate (e.g., hydrophobic-modified sodium metasilicate, also known as waterglass or liquid glass), para-xylenes (e.g., the vapor-deposited polymers sold under the trade name Parylene), and combinations thereof. In certain embodiments, the hydrophobic component may further comprise hydrated alumina (Al(OH)₃). In addition, a curing process may be applied to the hydrophobic componenet to promote the crosslinking of polymers.

In certain embodiments, the hydrophobic component may comprise a superhydrophobic surface. In certain embodiments, the superhydrophobic surface is a coating. Superhydrophobic coatings, also referred to as ultrahyrdophobic coatings, often mimic the very high water repellence exhibited by the leaves of the lotus flower. In certain embodiments, a super-hydrophobic surface may be made by combining microscale roughness to the hydrophobic component (e.g., the polysilazanes, polyolefins, polyhaloolefins, polyarylene sulfides, and sulfone polymers as described above) or to a material (e.g., the materials of the battery housing) such that water beads up into near-spherical droplets, which roll on or even bounce off the surface. Microscale roughness may result in micrometer and nanometer sized or smaller projections, bumps, or ridges on the super-hydrophobic surface. In certain embodiments, micro- and nanoscale roughness is made using laser patterning technique with femtosecond laser pulses that create an intricate pattern of micro- and nanoscale structures to the metal surface. In certain embodiments, a super-hydrophobic surface may be made by spraying, dipping or painting a suspension of nanoparticles (e.g., dual-scale nanoparticles of titanium dioxide (TiO₂) and titanium oxide (TiO) that are coated with perfluorooctyltriethoxysilane) onto a surface (e.g., the cathode housing, the anode cap, the gasket). In certain embodiments, a superhydrophobic surface may be made by patterning a metal surface by depositing a material (e.g., SiO₂) on to a surface of the battery and etching (e.g., chemical etching, reactive-ion etching) away portions of the surface or the material to form a superhydrophobic surface. Alternatively, a superhydrophobic surface may be made by simply removing (e.g., by etching) portions of the surface of the battery (e.g., the anode cap, the cathode housing). Additional examples of superhydrophobic surfaces include, but are not limited to, those disclosed in U.S. Patent Publication 2006/0029808, U.S. Patent Publication 2006/0110542, U.S. Pat. No. 6,660,363, U.S. Pat. No. 8,338,351, International PCT Publication No. WO 2015/048504, each of which is incorporated by reference in its entirety.

In certain embodiments, the hydrophobic component is also lipophobic (e.g., an omniphobic component.) Without intending to be bound by any particular theory, an omniphobic material may be advantageous because the likelihood of surface fouling is decreased due to the repellency of both hydrophilic and hydrophobic compounds. In certain embodiments, the omniphobic component is a conductive slippery liquid-infused porous surface (SLIPS). For example, a surface of the battery (e.g., anode cap or the cathode housing) may have features that provide microscale roughness (i.e., a roughened surface) to the battery. In certain embodiments, the roughened surface may be manufactured by applying a coating (e.g., a polymer coating) or by etching of the surface of the battery. The application of a liquid wets the roughened surface, filling the hills, valleys, and/or pores of the roughened surface, and forming an ultra-smooth surface over the roughened surface. In certain embodiments, the roughened surface and the liquid have an affinity for each other such that liquid is substantially immobilized on the surface of the battery. In some embodiments, the roughened surface comprises one or more polytetrafluoroethylene-based polymers, fluorogels, or vascularized polymer networks. In certain embodiments, the infused liquid may comprise one or a combination of silicone oils, fluorinated oils, perfluorocarbons, electrically conductive turbine oils, or dielectric gels. In certain embodiments, the SLIPS may be self-healing such that the infused liquid, which remains trapped (e.g., by the polymer network of the roughened surface), imparts scratch resistance to the coating, and readily fills defects in the coating. Additional examples of SLIPS include, but are not limited to, those disclosed in International PCT Publication No. WO 2012/100100, which is hereby incorporated by reference in its entirety.

In certain embodiments, a surface of the battery or parts thereof is coated with a conductive omniphobic material. In some of these embodiments, the conductive omniphobic material is a liquid infused porous network, fluorogel or vascularized polymer network. In some embodiments, electrically conductive oils (e.g., turbine oils), are used as the infused liquid to render the SLIPS conductive. In certain embodiments, the infused liquid or the supporting network are doped with conductive materials such as carbon black, carbon nanotubes, graphene, and/or metal particles.

In certain embodiments, the hydrophobic component may result in a water contact angle greater than about 100° , greater than about 120° , greater than about 135° , greater than about 150° , or even greater than about 165° . In certain embodiments, the hydrophobic component may result in a surface energy less than about 40 dynes/cm, less than about 35 dynes/cm, less than about 30 dynes/cm, or even less than about 25 dynes/cm.

In certain embodiments, the hydrophobic component is provided as a pattern. The term “pattern” as used herein means an intentional arrangement of elements on a surface in such a way that hydrophobic component may not cover the entire surface, preferably leaving uncoated spaces that are too small to be effectively wet by a high-surface-tension polar liquid such as water, but that allow electrical contact to occur through the gaps in the hydrophobic component. A pattern may be geometric or repetitive or both. The pattern may be regular or irregular.

In certain embodiments, the hydrophobic component is a patterned metal surface with hierarchical micro- and nano-structure in which the patterning imparts hydrophobicity. In some embodiments the pattern is applied by laser etching. In certain embodiments, the metallic anode cover of the battery is laser-etched to create a hierarchical hydrophobic surface. In certain embodiments, an additional metal or metal alloy is deposited on the laser etched battery surface to improve the hydrophobicity of the anode cover. In some embodiments, the anode cover ccomprises (e.g., as a surface layer, or as the entire cover) brass, titanium, platinum, or a noble metal, which is then etched to impart superhydrophobicity.

In certain embodiments, the hydrophobic component comprises a dispersed metal, such as conductive nanoparticles and/or microparticles of metallic nickel, reduced titania, metallic zirconium, silver, silver plated nickel, silver plated aluminum, silver plated copper, carbon, gold, lithium, a lithium-based alloy, metallic titanium, grade 2 titanium, titanium nitride, a titanium-based alloy, nickel, metallic copper, tin, zinc, a copper-tin-zinc alloy, tantalum, niobium, boron-doped diamond, stainless steel, grade 304 stainless steel, duplex stainless steel and combinations thereof.

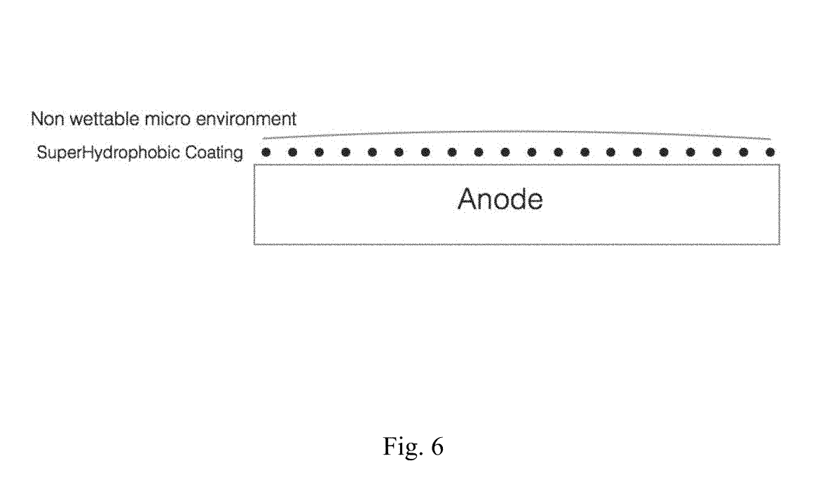

As depicted in FIG. 6, the superhydrophobic coating may be applied to the external surface of the anode cap. The superhydrophobic coating may comprise pinholes and/or dispersed nano and/or micro conducting materials. The superhydrophobic coating creates a non wettable air interface between the battery and an aqueous environment (e.g., the biological environment of the digestive tract if swallowed). In an aqueous environment, battery is inactive. When the battery is placed in an electronic device, a corresponding component in the device (e.g., a patterned spring, a patterned arm) will displace the air interface to permit electrical communication affording an active battery. Although FIG. 6 depicts a superhydrophobic coating applied to the anode, in certain embodiments, the superhydrophobic coating may be disposed on another surface of the battery (e.g., cathode housing, gasket).

In certain embodiments, the hydrophobic component comprises a conductive polymer. Examples of conductive polymers include, but are not limited to, polypyrrole, polyaniline, polyacetylene, polythiophene, polyphenylene vinylene, polyphenylene sulfide, poly p-phenylene, and polyheterocycle vinylene.

In certain embodiments, the hydrophobic component may be a coating applied to one surface of the anode cap (optionally coating a portion of the gasket but yet without forming electrical contact with the cathode housing), to one surface of the cathode housing, or to both the anode cap and the cathode housing in any suitable manner including, for example, spraying, brushing, dipping, gravure printing, nanolithographic techniques or vapor deposition. The coating may additionally be applied to the gap between the anode cap and the cathode, such as on the gasket. In certain embodiments, a coating may cover the gasket and one entire terminal (e.g., the anode cap or the cathode housing), but does not extend onto the other terminal (i.e., the terminal not covered by the coating).

In certain embodiments, the battery further comprises a radiopaque material disposed in or on the battery, e.g., presenting a distinctive shape, sign, or pattern. For example, a marking may be placed on the anode cap, the cathode housing, or any other suitable part of the housing, to allow a treating physician to ascertain via X-ray imaging whether the type of battery swallowed is one according to this invention, i.e., presents a less urgent medical issue than a conventional-type battery, or simply to distinguish a battery from a similarly-shaped object such as a coin. In certain embodiments, the radiopaque material may be disposed in the gasket. Radiopaque material is any material applied that is not transparent to X-rays or other forms of radiation and can be distinguished from the material that forms the anode cap and/or the cathode housing in an X-ray image. Examples of radiopaque materials include, but are not limited to, tungsten, tungsten dioxide, tungsten trioxide, stainless steel powder, silver iodide, iodinated organic compounds, gold, nickel alloys, titanium, titanium dioxide, tantalum, iodine and barium, and salts thereof and radiopaque polymers. In certain embodiments, the radiopaque marker may be defined by altering the radiopacity of the battery, e.g., by etching (e.g., via laser or chemically) or by machining away material from the cathode housing or anode cap. In certain embodiments, the radiopaque material (e.g., a sheet, a sphere, or any other two- or three-dimensional object) may be located within the battery, e.g., disposed between the anode cap and the cathode housing.

In certain embodiments, the gasket may comprise nylon, polyethylene, polysilazanes, polyolefins, polyhaloolefins, polyarylene sulfides, and sulfone polymers including, but not limited to, perhydropolysilazanes, polyfluorosilazanes, polyperhydridosilazanes (PHPS), inorganic polysilazanes, organopolysilazanes (e.g., the polysilazanes sold under the trademark Durazane by EMD Performance Materials), polyethylene, polypropylene, polybutylene, polymethylpentylene, polytetrafluoroethylene (PTFE), polyvinyl fluoride (PVF), polyvinylidene fluoride (PVDF), polychlorotrifluoroethylene (PCTFE), polyvinyl chloride (PVC), polyvinylidene chloride (PVDC), chlorinated polyvinylchloride (C-PVC), fluorinated ethylene-propylene copolymer (FEP), ethylene-chlorotrifluoroethylene copolymer (E-CTFE), ethylene-tetrafluoroethylene copolymer (ETFE), perfluoroalkoxy resin (PFA), propylene hexafluoride such as sold under the trademark TEFLON® EPE, polyphenylene sulfide, polynaphthalene sulfide, chlorotrifluoroethylene, fluorinated ethylene-propylene, polytetrafluoroethylene, perfluoroalkoxy polymer, polypropylene, polystyrene, polysulfone, polyvinyls, doped ionomers (such as Surlyn® (poly(ethylene-co-methacrylic acid), sodium salt)), polyphosphazenes, polyacrylonitrile, natural and synthetic rubber (e.g., styrene-butadiene, styrene-butadiene rubber), poly(styrene-butadiene-styrene), polyurethanes, or any combination (e.g., copolymers or mixtures) thereof.

In certain embodiments, the hydrophobic component coating may also comprise a metal chelating agent. For example, the metal chelating agent may be disposed in the gasket or on an external surface of the battery. By way of non-limiting example, suitable chelating agents include aconitic acid, alanine diacetic acid (ADA), alkoyl ethylene diamine triacetic acids (e.g., lauroyl ethylene diamine triacetic acids (LED3A)), aminotri(methylenephosphonic acid) (ATMP), aspartic acid diacetic acid (ASDA), aspartic-N-monoacetic acid, diamino cyclohexane tetraacetic acid (CDTA), citraconic acid, citric acid, 1,2-diaminopropanetetraacetic acid (DPTA-OH), 1,3-diamino-2-propanoltetraacetic acid (DTPA), diethanolamine, diethanol glycine (DEG), diethylenetriaminepentaacetic acid (DTPA), diethylene triamine pentamethylene phosphonic acid (DTPMP), diglycolic acid, dipicolinic acid (DPA), ethanolaminediacetic acid, ethanoldiglycine (EDG), ethionine, ethylenediamine (EDA), ethylenediaminediglutaric acid (EDDG), ethylenediaminedi(hydroxyphenylacetic acid (EDDHA), ethylenediaminedipropionic acid (EDDP), ethylenediaminedisuccinate (EDDS), ethylenediaminemonosuccinic acid (EDMS), ethylenediaminetetraacetic acid (EDTA), ethylenediaminetetrapropionic acid (EDTP), ethyleneglycolaminoethylestertetraacetic acid (EGTA), gallic acid, glucoheptonic acid, gluconic acid, glutamic acid diacetic acid (GLDA), glutaric acid, glyceryliminodiacetic acid, glycinamidedisuccinic acid (GADS), glycoletherdiaminetetraacetic acid (GEDTA), 2-hydroxyethyldiacetic acid, hydroxyethylenediaminetriacetic acid (HEDTA), hydroxyethyldiphosphonic acid (HEDP), 2-hydroxyethyl imino diacetic acid (HIMDA), hydroxyiminodiacetic acid (HIDA), 2-hydroxy propylene diamine disuccinic acid (HPDDS), iminodiacetic acid (IDA), iminodisuccinic acid (IDS), itaconic acid, lauroyl ethylene diamine triacetic acids (LED3A), malic acid, malonic acid, methylglycinediacetate (MGDA), methyliminodiacetic acid (MIDA), monoethanolamine, nitrilotriacetic acid (NTA), nitrilotripropionic acid (NPA), N-phosphonomethyl glycine (glyphosate), propyldiamine tetraacetic acid (PDTA), salicylic acid, serinediacetic acid (SDA), sorbic acid, succinic acid, sugars, tartaric acid, tartronic acid, triethanolamine, triethylenetetraamine, triethylene tetraamine hexaacetic acid (TTHA), and combinations thereof

In certain embodiments, the battery may comprise an indicator element that when exposed to water changes color, e.g., disposed in the water-permeable gasket or on an exterior surface of the battery. In certain embodiments, the indicator element may be water-soluble such that it is released from the battery when the battery contacts water. In certain embodiments, the indicator element may be capable of leaching from the battery when the battery is in an aqueous environment and that, when ingested by a mammal, dyes the urine of the mammal a distinctive (e.g., non-yellow) color. Examples of indicator elements include, but are not limited to, Yellow No. 5, (3-carotene, rifampin, Yellow No. 6, tetracycline, Red No. 40, Red No. 3, Blue No. 2, Evan's Blue, Green No 3, Blue No. 1, methylene blue, indocyanine green, Betanin, and beet juice (or anthocyanines or other food-based dyes), and combinations thereof.

In certain embodiments, the battery further comprises an aversive agent. Various aversive agents can be employed including, for example and without limitation, natural, artificial and synthetic flavor oils and flavoring aromatics and/or oils, oleoresins and extracts derived from plants, leaves, flowers, fruits, and so forth, and combinations thereof. Nonlimiting representative flavor oils include spearmint oil, peppermint oil, eucalyptus oil, oil of nutmeg, allspice, mace, oil of bitter almonds, menthol and the like. Also useful aversive agents are artificial, natural and synthetic fruit flavors such as citrus oils including lemon, orange, lime, grapefruit, and fruit essences and so forth. Additional aversive agents include sucrose derivatives (e.g., sucrose octaacetate), chlorosucrose derivatives, quinine sulphate, and the like. Additional aversive agents that may have pungent properties include but are not limited to capsaicin, piperine, allyl isothiocyanate, and resinferatoxin. An exemplary commercially available aversive agent includes Denatonium Benzoate NF-Anhydrous, sold under the name Bitterant-b, BITTER+PLUS, Aversion, or Bitrex™ (Macfarlan Smith Limited, Edinburgh, UK)

In certain embodiments, the battery may have an aesthetically unappealing appearance. For example, the anode cap and/or the cathode housing may have a dull, dark (e.g., gray, black) color. In certain embodiments, the battery may have a non-glossy or matte finish.

Preferred embodiments of this invention are described herein with reference to the drawings. Of course, variations, changes, modifications and substitution of equivalents of those preferred embodiments will become apparent to those of ordinary skill in the art upon reading the foregoing description. The inventors expect skilled artisans to employ such variations, changes, modifications and substitution of equivalents as appropriate, and the inventors intend for the invention to be practiced otherwise than specifically described herein. Those of skill in the art will readily recognize a variety of non-critical parameters that could be changed, altered or modified to yield essentially similar results. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

While each of the elements of the present invention is described herein as containing multiple embodiments, it should be understood that, unless indicated otherwise, each of the embodiments of a given element of the present invention is capable of being used with each of the embodiments of the other elements of the present invention and each such use is intended to form a distinct embodiment of the present invention.

Incorporation by Reference

All publications and patents mentioned herein are hereby incorporated by reference in their entirety as if each individual publication or patent was specifically and individually indicated to be incorporated by reference. In case of conflict, the present application, including any definitions herein, will control.

Equivalents

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

What is claimed is:

1. A battery comprising:
an anode cap;
a cathode housing;
an electrochemical cell comprising an anode material, a cathode material, and a separator disposed between the anode material and the cathode material;
a gasket joining the anode cap to the cathode housing; and
a hydrophobic component disposed on at least one of the anode cap, the cathode housing, and the gasket.

2. The battery according to claim 1, wherein the hydrophobic component is a coating.

3. The battery of claim 1, wherein the hydrophobic component has a water contact angle greater than about 100° .

4. The battery of claim 1, wherein the hydrophobic component has a water contact angle greater than about 120° .

5. The battery of claim 1, wherein the hydrophobic component has a water contact angle greater than about 135° .

6. The battery of claim 1, wherein the hydrophobic component has a water contact angle greater than about 150° .

7. The battery of claim 1, wherein the hydrophobic component has a water contact angle greater than about 165° .

8. The battery of claim 1, wherein the hydrophobic component has a surface energy less than about 35 dynes/cm.

9. The battery as in claim 1, wherein the hydrophobic component has a surface energy less than about 30 dynes/cm.

10. The battery as in any claim 1, wherein the hydrophobic component has a surface energy less than about 25 dynes/cm.

11. The battery of claim 1, wherein the hydrophobic component further comprises a superhydrophobic surface.

12. The battery of claim 11, wherein the superhydrophobic surface is a coating.

13. The battery of claim 11, wherein the superhydrophobic surface comprises a patterned metal surface.

14. The battery of claim 12, wherein the superhydrophobic coating comprises nanoparticles.

15. The battery of claim 1, wherein the hydrophobic component comprises a polysilazane.

16. The battery of claim 1, wherein the hydrophobic component comprises a metal.

17. The battery of claim 16, wherein the metal comprises, e.g., as nanoparticles and/or microparticles, a material selected from metallic nickel, reduced titania, metallic zirconium, silver, silver plated nickel, silver plated aluminum, silver plated copper, carbon, gold, lithium, a lithium-based alloy, metallic titanium, grade 2 titanium, titanium nitride, a titanium-based alloy, nickel, metallic copper, tin, zinc, a copper-tin-zinc alloy, tantalum, niobium, boron-doped diamond, stainless steel, grade 304 stainless steel, duplex stainless steel, or any combination thereof.

18. The battery of claim 1, wherein the hydrophobic component is provided as a pattern coating.

19. The battery of claim 18, wherein the pattern coating is a mesh.

20. The battery of claim 1, wherein the battery further comprises a radiopaque element.

21. The battery of claim 1, wherein the battery is a button or a coin cell.
